(19) United States
(12) Patent Application Publication
(10) Pub. No.: US 2005/0192879 A1
(43) Pub. Date: Sep. 1, 2005

(54) Collaborative shared services business system, business processes and method thereof

(76) Inventor: Guy Rabbat, San Jose, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/821,692

(22) Filed: Apr. 9, 2004

Related U.S. Application Data
(60) Provisional application No. 60/548,196, filed on Feb. 27, 2004.

(51) Int. Cl. G06F 17/60

(52) U.S. Cl. 705/35; 705/19; 705/37

(57) ABSTRACT

An embodiment of the present invention is a business process shared services system and method for improving business operations by collaboratively managing operational support services, functions and/or resources. This is accomplished by employing a collaborative shared services business system strategy containing some of the key business model advantages of shared service functions, outsourced services, collective approach, cooperatives, and mutual funds. The collaborative shared services business system (System) is engaged in managing business support operations, functions, services or resources at a lower cost and higher performance to maximize profitability. Under this system a for-profit business entity, which is shareholder-owned, professionally manages the collaborative shared services and provides desired business operational support services to their customers at lower costs, while providing for lower taxes; better performance; share in profits through dividend distributions, and/or deductible benefits resulting from operational efficiencies; and increased velocity of cash flow.

### CROSS REFERENCE

This application claims the benefit of priority from U.S. Provisional Application No. 60/548,196, entitled “Collaborative Services Business System, Business Processes and Method Thereof” and filed Feb. 27, 2004, which is herein incorporated by reference.

### BACKGROUND OF THE INVENTION

1. Field of Invention

The present invention generally relates to business process services systems and, in particular, to a collaborative shared services business system including processes and methods for improving business operations through the acquisition and management of collaborative business support services, operations, functions, or resources by a for-profit business entity.

2. Background of the Invention

Companies are constantly challenged to improve their operational efficiency, increase profit margins, and cut costs. Senior managers of mid- to large-size companies are pressured to: (1) reduce headcount based on declining sales and profits; (2) maintain baseline operations during declines in sales or orders; and (3) reduce the amount of management time invested in overseeing processing activities. The high turnover of business support staff alone can lead to higher training and retention costs, a loss of key business knowledge, a disruption to routine business activities, and high-cost write-offs due to the lack of timely issue resolution with vendors and suppliers. Further problems encountered that are caused by maintaining baseline operations with limited staff include sub-optimal tasks for highly skilled staff and lack of funds to hire additional staff. The continued drive to cut costs and increase efficiency in finance and accounting departments, for example, is driving many companies to outsource these functions.

Senior executives are commonly turning to business process outsourcing (BPO) solutions to address these concerns. BPO is a strategy whereby a company contracts with a third party to perform a needed service on its behalf. The arrangement frequently involves a sale/transfer of assets to the third party and a reduction or elimination of the department(s) that previously performed the needed service. For these reasons, outsourcing enables the contracting firm to transform some of its fixed, overhead costs, into variable, transaction-based costs.

BPO can be used by firms that are working to focus on their core business activity and strategic functions while still maintaining access to solutions for their non-strategic yet essential functions. For the past decade, companies have been driving toward moving as much of their non-strategic business processes to strategic vendors as possible. This outsourcing trend is most prevalent within manufacturing, human resources, payroll, and information technology services. Much of the outsourcing utilized goes to offshore operations.

Current outsourcing services range from finance functions to the management, reconciliation and resolution of supply chain operations. Benefits that firms may realize from outsourcing include the ability to convert fixed costs to variable costs, elimination of process backlogs, cost savings, discovery of new process efficiencies, and better utilization of limited staff by relieving them of mundane and problematic processes. Much of the cost savings are due to the access to lower international labor costs. However, with current outsourcing models, customers lose control of the outsourced business functions, frequently resulting in a reduction in force (lay-off) of an entire support department, e.g. Human Resources. In addition, the transfer of services can be costly and significantly disruptive to the customer's business, depending on the scope and manner of the transfer.

Premium business support functions are also provided via other business models, such as those used for shared service organizations, collective approach, cooperatives, and mutual funds. While each of these approaches can achieve some of the same goals as outsourcing, like outsourcing, each also has its drawbacks and limitations.

For example, the shared services model is one approach that is gaining momentum throughout the high-tech industry as a strategy for administering company-wide support services in decentralized, multidivisional firms. By consolidating and centralizing transaction-intensive, back office operations, these firms optimize overhead spending and increase process efficiencies. As long as the operation is held in-house, however, the related costs are still classified as overhead, and the firm still needs to manage the required assets and personnel. This is why shared services departments typically become outsourced to independent third party companies that perform the non-strategic, yet essential, activities of the firms that contract them (e.g. human resources, administration, accounting, purchasing, etc.). Outsourcing allows firms/businesses/companies to convert fixed costs to variable operations-related expenses, however, the organization is then subject to the same problems/issues found with BPO, in that customers lose control of the business functions that are outsourced, eventually resulting in the lay-offs of entire support staff departments.

Some have attempted to implement a business model which uses a collective approach model to provide business support services from suppliers to independent companies, tradespersons, or professionals operating in a common field of endeavor, through a substantially liquid-asset based, for-profit business entity. Under this system, independently owned and operated participant firms are assigned geographically-protected business locations. Participants receive enhanced purchasing power and other marketing advantages/capabilities to better compete with larger companies, and the assurance that the collective business entity will not also support another participant within the described geographical territory. This model provides an inherent competitive advantage similar to that of a franchiser for its franchisees. Unlike the BPO model, in the collective approach model the third party entity does not assume participant assets nor entirely replaces a participant's service organization. The shortcomings of this approach, affecting mostly large companies, is that the benefits are mainly targeted toward smaller companies based on geographical exclusivity with a focus on small businesses operating in a common field of endeavor. Put another way, the collective approach model is neither applicable nor available to large national firms operating in different industries, such as those found in most major metropolitan areas.

The cooperative (co-op) is a more traditional business system common among smaller to mid-size businesses, which allows groups of independently owned businesses with common interests to successfully compete in the marketplace by pooling resources for their mutual benefit. A co-op is a form of business organization that is owned and controlled by the people who use its products, supplies or services. Co-ops are defined as corporations owned and controlled by their members (shareholders). Co-ops are very flexible and commonly used for purchasing, handling of receivables, and providing shared services. Examples of some shared services provided to corporate groups include: information technology, finance functions, human resources, and payroll, to name a few. Other added benefits of a co-op include efficient coordination with suppliers and greater purchasing power. Purchasing and shared services co-ops are commonly used by franchise systems and other industries. A credit union is an example of a member-owned, non-profit, financial co-op organized by consumers to encourage savings and to obtain loans at the lowest possible cost.

Under special tax rules, co-ops can avoid tax on their earnings if they distribute them as patronage dividends to their members. These rules apply regardless of a co-op's non-profit or for-profit status. A co-op can eliminate tax in the current year by accruing a deduction for patronage dividends, and members of the co-op are taxed on the patronage dividends only in the following year when the patronage dividends are actually received. Co-ops distribute their earnings or profits to members as patronage dividends in proportion to their purchases.

Tax benefits associated with co-ops can flow from 26 United States Code, Subtitle A, Chapter 1, Subchapter T (Subchapter T), which allows co-ops to take a tax deduction for patronage dividends, thus avoiding corporate level tax on patronage earnings. However, to qualify for Subchapter T tax treatment (tax deduction for patronage dividends), the entity must operate on a cooperative basis. For example, the patronage dividends must be allocated to members in proportion to quantity or value of patronage business. The patronage dividends must be paid pursuant to a pre-existing legal obligation, usually provided for in the bylaws. The patronage dividends must be determined with reference to net earnings of the co-op and they must be distributed within eight and a half months after the year's end.

A summary of current tax deferrals that are available to a co-op and its members include: “permanent” deferral of intercompany profit on purchases of inventory goods and services by the members from the cooperative; permanent deferral of intercompany profit on non-inventory goods and shared services provided by the cooperative to its members; permanent deferral for prepayment by the members to the co-op of approximately three and a half months of non-inventory goods and shared service fees; and, permanent deferral of intercompany factoring discount on accounts receivable sold by members to the co-op. To qualify for a tax deferral for patronage dividends and for a three-and-a-half-month prepayment strategy, the co-op must not be included in a consolidated return filing with its parent. A co-op is required to be in a consolidated return if members owning both 80% of its equity and possessing 80% of its voting power are included in the consolidated return. Thus, the co-op's membership must be structured so that more than 20% of its equity or 20% of its voting power is in the hands of unrelated members, or related members who are not included in a consolidated return, e.g. partnerships, LLCs, or foreign-controlled corporations. Other key factors required for a co-op to be eligible for tax deferral benefits are: 1) ownership is limited to the patrons; 2) all patronage earnings, whether paid out as dividends or not, must be reported as taxable income by the patrons; 3) ownership of the co-op's equity is held by its members in proportion to their patronage; and 4) each member has only one vote in governing the co-op.

The co-op, however, is a business organization that is typically limited to addressing one type of business operation need, e.g., purchasing, sales, advertising, and marketing. For example, new car dealers and fast food franchisees typically form marketing and advertising co-ops whose sole function is marketing and advertising in a given region. As with the collective approach model, co-ops have limited applicability to large business enterprises, and firms typically use them as an adjunct to, not a replacement of, necessary in-house service functions. Traditionally, co-ops were useful for promoting the interests of smaller businesses, finding that they could accomplish more collectively than they could individually.

A mutual fund is still another vehicle whereby individuals or entities engage a third party to provide services and/or manage resources. It is an approach that satisfies investors' need for capital growth, income and/or income preservation easily and at less cost than if undertaken solely. A mutual fund is an open-end investment company that pools the money of many investors—its shareholders—to invest in a variety of securities. By pooling the funds of thousands of investors, mutual funds provide full-time, high-level professional management that few individual investors can afford to obtain independently. Investments may be in stocks, bonds, money market securities or some combination of these. The securities are professionally managed on behalf of the shareholders, and each investor holds a pro rata share of the portfolio. Shareholders are entitled to any net earnings when the securities are sold, and are also subject to any loss in value. By its very nature, a mutual fund is diversified, in that its assets are invested in many different securities. Mutual funds bring the benefits of diversification and money management to the individual investor, providing an opportunity for financial success that was not otherwise available to smaller investors. Mutual funds provide the benefit of having a central management to manage the investments, take care of record-keeping, and diversify the investments over many different securities that may not otherwise be available or affordable to the individual investor. The managers typically charge an annual fee, generally some percentage of the fund's assets, and may also charge for expenses.

One drawback to the mutual fund approach is that while the shareholders are entitled to any net earnings when the securities are sold, they are also subject to any loss in value. Further, fund managers decide what securities to trade, while investors simply hold a pro rata share of the portfolio developed by the fund manager. Lastly, capital gains from distributions to the shareholders generally do not receive special tax treatment.

There is a need in the art, therefore, for a collaborative shared services business system, including processes and methods that are applicable to small to large businesses, which allows businesses to cut costs and increase productivity and efficiency by transferring operational support functions while still retaining control over the transferred operational support functions. The prior art discloses a collective system that offers premium business support mechanisms on an outsource level to a group of independently-owned companies, tradespersons or professionals engaged in a common field of endeavor. The prior attempts are primarily focused on helping smaller businesses compete effectively with much larger competitors in their industry and do not consider collaborating participants/recipients with suppliers/vendors, or providing tax benefits.

Accordingly, it is a principal object of the invention to allow small to large independent businesses increase efficiency and reduce cost of business operations through collaborative acquisition and management of operational support services or functions by a for-profit business entity, while allowing the participating companies to maintain control of the business operations through their voting power in the entity.

There is also a need in the art for cash optimization solutions for businesses. Revenue leaks corrode company financials in virtually every industry. Overall, United States businesses report $81 billion in revenue leaks annually. The telecom industry alone reports average revenue leaks of 2-10%. Furthermore, losses increase during declining markets. Leaks generally result from operational process inefficiencies and inaccuracies from manual steps.

It is a further object of the invention to provide cash optimization solutions to businesses through: 1) optimal cash-to-cash cycles, 2) solutions and services for cash optimization, 3) techniques to uncover revenue leaks, 4) intelligent metrics, and 5) increased finance visibility to operations.

### SUMMARY OF THE INVENTION

The embodiments of the present invention solve the problems and address the drawbacks of the approaches in the above description. An embodiment of the present invention is a shareholder-owned, for-profit, collaborative shared services business system (System) in which shareholder companies transfer business support resources or assets to a for-profit business entity in exchange for high quality, cost efficient, business operational support services and the management of those services.

In the System, the customers or member companies may also be shareholders. Customer/shareholder in-house fixed costs for business operational support functions become variable with the System. Under the System, the for-profit business entity (Entity) professionally manages the acquired collaborative shared services and provides desired business operational support services to its customers/shareholders at lower costs, and with better performance, lower taxes, dividend distributions and/or deductible benefits such as volume discounts, rebates and warrants, and increased velocity of cash flow. Further, as shareholders, these member companies maintain control of their business operations.

An embodiment of the present invention is an evolved strategy combining the key business model advantages of shared service functions, outsourced services, collective approach, cooperatives, and mutual funds. The present collaborative shared business system is comprised of several factors that should work together, including:
1. A for-profit business entity (Entity);
2. One or more customers/shareholders, giving control of the business operational services, functions, and/or resources of the Entity to the customers/shareholders by way of their voting power;
3. A transfer or sale of resources or assets from one or more customers/shareholders to the Entity;
4. A means to distribute costs saved and/or profits to the customers/shareholders for operating efficiencies including but not limited to distribution of dividends, volume discounts, rebates, and warrants;
5. Special tax treatment for the business system or deductibility of benefits received for operating efficiencies;
6. A buy-by-service scheme that converts fixed costs to variable costs by enabling customers/shareholders to choose what and how much to purchase;
7. A variety of one or more business support services, functions or resources;
8. A team of management professionals;
9. An option to outsource to a third party supplier licensed by the Entity.

The embodiment of the present invention efficiently serves small to large sized companies. Non-strategic, non-essential, or peripheral support services are sometimes referred to as “back-office” services. Customers/shareholders transfer designated back-office, business operational support services, functions, and/or resources to the Entity, which then become collaborative shared services of the Entity.

Some examples of collaborative shared services include but are not limited to: accounts receivable administration, accounts payable administration, human resources, eLearning (computer training), general training, purchasing, information technology, manufacturing, engineering and design, and procurement. These collaborative shared services are assets of the Entity. These assets can be located anywhere, and they need not be located together in one physical location. The assets can even be located on the premises of one or more customers/shareholders initially, and moved to a more central location as efficiency requires. The Entity can include one or more sub-Entities within the Entity, the sub-Entities being specialized in one particular business operational support service or function.

The Entity professionally and cost-effectively manages and provides these collaborative shared services to its customers/shareholders. The Entity is not precluded from subsequently outsourcing its own business operational support services or functions to other third-party suppliers or vendors licensed by the Entity.

The Entity charges its customers a fixed percentage fee on a per-transaction basis for its management of the collaborative shared services. Profits realized by the Entity can be distributed to the shareholders as patronage dividends. Some profits may also be used to invest in the technology and skill of the Entity. A special tax treatment for patronage dividends is afforded, for example, provided the Subchapter T requirements for membership of the Entity are met.

Subchapter T, as noted above, requires that either 1) more than 20% of the Entity's equity or 2) more than 20% of the Entity's voting power is owned by unrelated members, or related members who are not included in a consolidated return, e.g. partnerships, LLCs, or foreign-controlled corporations. Other factors to consider for a co-op to qualify for tax deferral benefits include: 1) ownership is limited to the patrons; 2) all patronage earnings, whether paid out as dividends or not, must be reported as taxable income by the patrons; 3) ownership of the co-op's equity is held by its members in proportion to their patronage; and 4) each member has only one vote in governing the co-op. Some of the key advantages offered by the embodiment of the present invention to its customers/shareholders include:
1. Professional central management of business operational support services, functions or resources;
2. Retention of control over business support operations by the shareholders;
3. Conversion of fixed overhead costs to variable expenses;
4. Operating cost reductions;
5. Greater efficiency;
6. Highest performance;
7. Lower taxes or other benefits such as volume discounts, rebates or warrants which can be deductible;
8. Increased velocity of cash flow;
9. Higher job retention; and
10. Dividend distribution and possible use of dividends to invest in technology and skill enhancements.

Embodiments of the present invention can also provide cash optimization solutions to businesses resulting in: 1) optimal cash-to-cash cycles, 2) solutions and services for cash optimization, 3) techniques to uncover revenue leaks, 4) intelligent metrics, and 5) increased finance visibility to operations.

In order to uncover revenue leaks, processes in the financial supply chain are analyzed, inefficiencies that lead to leaks are uncovered, and a revenue leak detector enables monitoring of results and savings.

To have intelligent metrics, a scorecard is created that details: financial and performance metrics integrated with operational processes; automated data collection from the company; common data structures; wireless data collection; and dynamic information translating into action when needed.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 refers to a basic structure and general operation of the collaborative shared services business system according to an embodiment of the present invention.

FIG. 2 refers to a basic structure and general operation of the collaborative shared services business system having more than one customer/shareholder according to an embodiment of the present invention.

FIG. 3 refers to a basic structure and general operation of the collaborative shared services business system having a sub-Entity within the Entity, where the sub-Entity can specialize in one particular business operational support service or function according to an embodiment of the present invention.

FIG. 4 refers to a basic structure and general operation of the collaborative shared services business system having multiple for-profit business Entities that are separately located according to an embodiment of the present invention.

FIG. 5 illustrates a chart comparing the advantages and disadvantages of embodiments of the collaborative shared services business system with the prior art.

### DETAILED DESCRIPTION OF SPECIFIC EMBODIMENTS

The description above and below and the drawings of the present document focus on one or more preferred embodiments of the present invention and also describe some exemplary optional features and/or alternative embodiments. The description and drawings are for the purpose of illustration and not limitation. Those of ordinary skill in the art will recognize variations, modifications, and alternatives. Such variations, modifications, and alternatives are also within the scope of the present invention. Section titles are terse and are for convenience only.

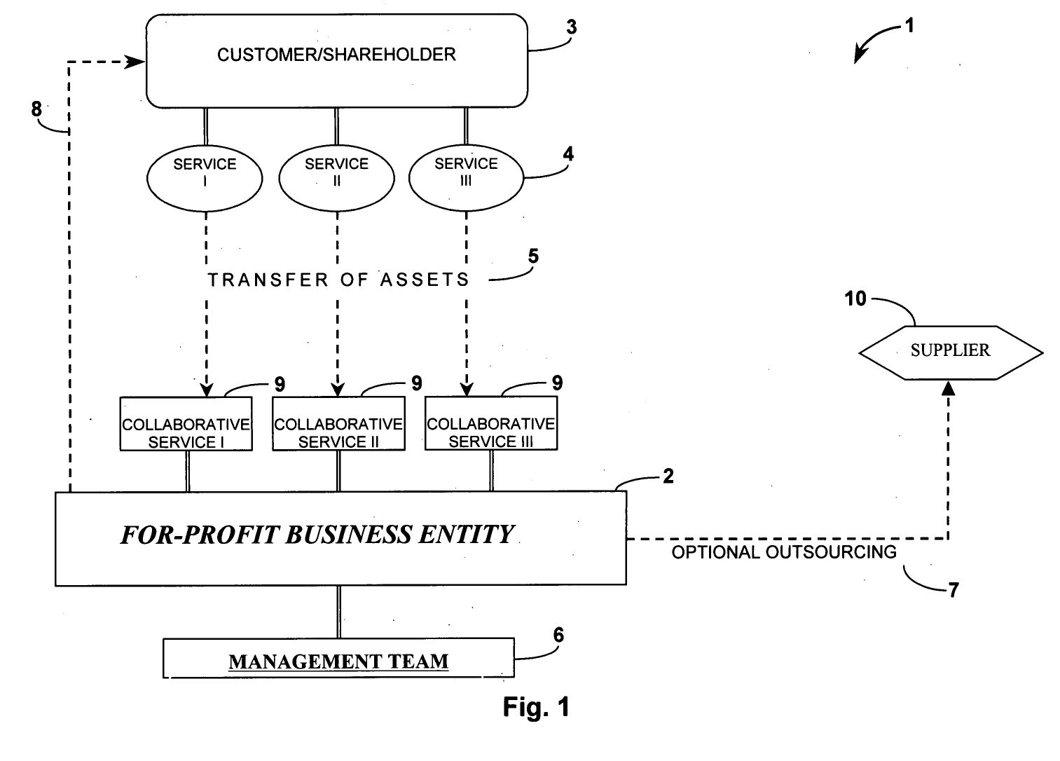

An embodiment of the present invention is a collaborative shared services business system (System) as shown in FIG. 1. The present System 1 is made up of several components that work together, comprising: a for-profit business entity (Entity) 2; one or more customers/shareholders 3 of the Entity 2; transfer of operational, support services, functions, and/or resources 5 from the customers/shareholders 3 to the Entity 2; one or more business support services, functions, or resources 4; one or more purchased assets that become part of a corresponding collaborative shared service 9; one or more management professionals 6; an optional outsourcing mechanism 7 to a third-party supplier 10 licensed by the Entity 2; and a means for profit sharing, such as but not limited to dividends, volume discounts, rebates or warrants 8.

The System in FIG. 1 is based on a collaboration model designed to benefit small to large size companies within a wide range of industries. In an embodiment of the present invention one customer/shareholder 3 transfers one or more of its operational, support services, functions, and/or resources 5 to the Entity 2. As a result, a flexible scheme emerges wherein fixed costs are converted into variable costs by enabling customers to chose what and how much to purchase; and at the same time the customers/shareholders maintain control of the collaborative shared services, functions or resources.

An initial cost reduction in business operations is realized because of the transfer of resources or assets 5 to the Entity 2. The Entity 2 may function as a hub or a business center. The operational, support services, functions, and/or resources 4 acquired by the Entity 2 become assets 9 of the Entity 2. These acquired assets become part of collaborative shared services 9 which are professionally managed by the Entity 2.

Collaborative shared services may include, but are not limited to, account receivables, account payables, human resources, eLearning, training, purchasing, information technology, engineering and design, manufacturing, and procurement. The Entity 2 collaboratively manages the shared services 9 with its management professionals 10. The Entity 2 provides its customers/shareholders 3 high quality collaborative shared services 9. The collaborative shared services 9 result in the highest performance because the centralized and uniform business processes of the System 1 generate new collaborative technologies, for example, standardized business transactions in the finance and engineering areas. The Entity 2 charges the customers/shareholders 3 a fixed percentage fee (e.g., on a per-transaction basis) for its management of the collaborative shared services 9.

This System 1 is highly desirable for a company because as a customer/shareholder 3 of the Entity 2, the customer/shareholder 3 can retain some control of their resources as a collaborative shared service 9. The Entity 2 is not precluded from subsequently outsourcing 7 business operational, support services, functions or resources to other third-party suppliers 10 licensed by the Entity 2. By charging the customers/shareholders 3 a fixed percentage fee on a per transaction basis for providing a collaborative shared service 9, the System 1 allows for a conversion of fixed costs to variable costs. The embodiment is not limited to this type of contractual agreement which is simply an example, and other contractual agreements are of course available, however because the Entity 2 charges by the services, the customers original fixed costs on the customers books are eliminated and converted into variable costs.

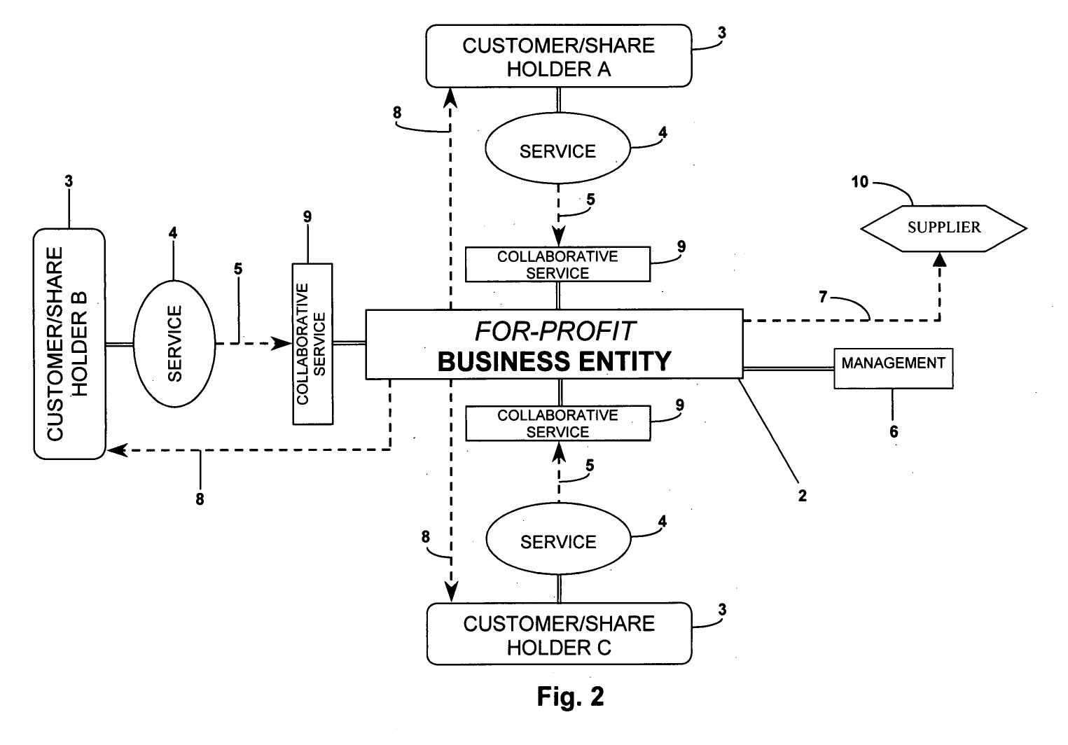

Another preferred embodiment of the invention is comprised of a collaborative shared services business system (System) as shown in FIG. 2. In the preferred embodiment, the Entity 2 is owned and controlled by more than one customer/shareholder 3. As the number of customers/shareholders 3 increases, the number of business operational support services, functions or resources 4 transferred 5 to the Entity 2 can increase as well. With increased resources or collaborative shared services 9 being managed by the Entity 2, the Entity 2 is better equipped to serve more customers/shareholders 3, further driving costs down and increasing tax benefits. Since the Entity 2 is not restricted by geography, industry, or field of common endeavor, the Entity 2 is able to allocate the collaborative shared services 9 over a broad range of customers/shareholders 3.

Another embodiment of the present invention can be a virtual Entity 2, where the operational support services, functions, and/or resources 5, although becoming assets of the Entity 2, remain physically present on-site at the company 3. Thus, part of the Entity 2 or center of business operations (hub) is located on customer/shareholder premises 3 by virtue of the Entity's 2 assets and/or collaborative services 9 remaining physically present on-site with the customer/shareholder 3. However, the Entity's 2 central management 6 may be located off-site and remain free to optimize the Entity's 2 own resources for efficiency, and obtain better discounts from its own suppliers 10.

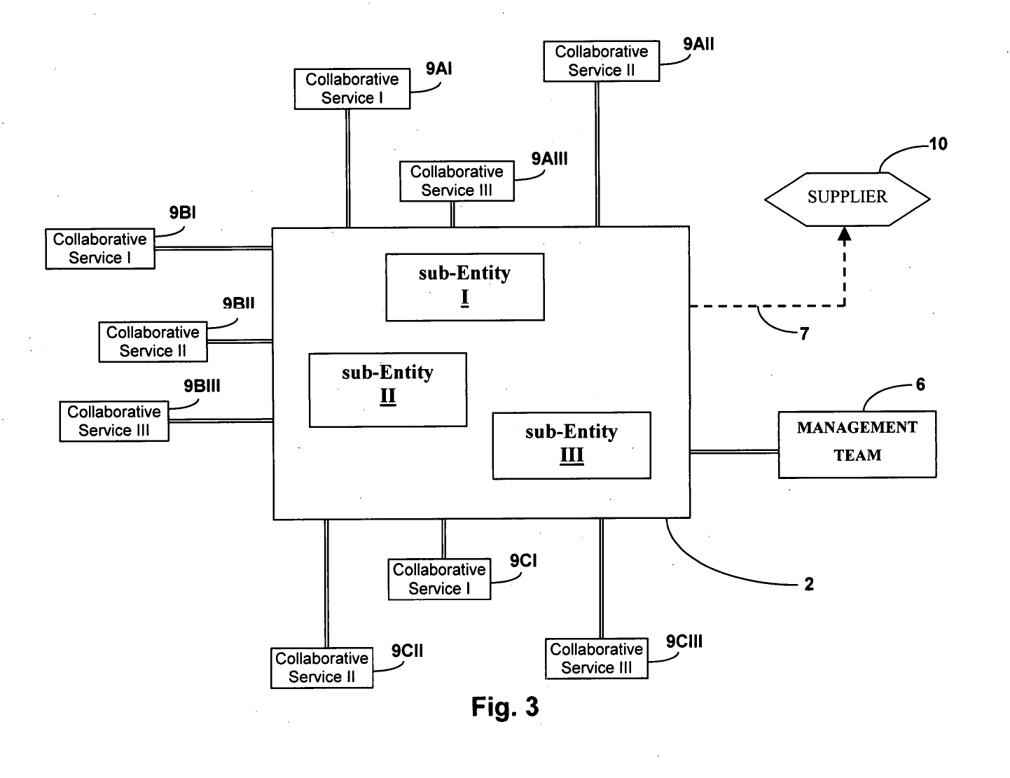

Yet another embodiment of the present invention is a collaborative shared services business system (System) having a sub-Entities I-III within an Entity 2, as shown in FIG. 3. To maintain efficiency and productivity as the number and variety of purchased assets and/or resources 9AI-9AIII, 9BI-9BIII, 9CI-9III among the different shareholders increase, it may become necessary to form one or more sub-Entities I-III within an Entity 2. When the number of assets and/or resources purchased 9AI-9AIII, 9BI-9BIII, 9CI-9CIII for specific business support services and/or functions becomes great, better-targeted management may result when the Entity 2 is reorganized, and a sub-Entities I-III within an Entity 2 is formed, specializing in specific business support services and/or functions, e.g. Entity-Human Resources or Entity-Information Technology. As an embodiment of the present invention, the sub-Entity(s) I-III within the Entity 2 are separate but not independent from the Entity 2. The sub-Entity(s) I-III within the Entity may still rely on the Entity 2 for cross-support of other business operational functions and/or services 9AI-9AIII, 9BI-9BIII, 9CI-9CIII. Dividend distribution to all of the customers/shareholders in this embodiment is derived from costs saved by the Entity 2 plus all the sub-Entities I-III combined.

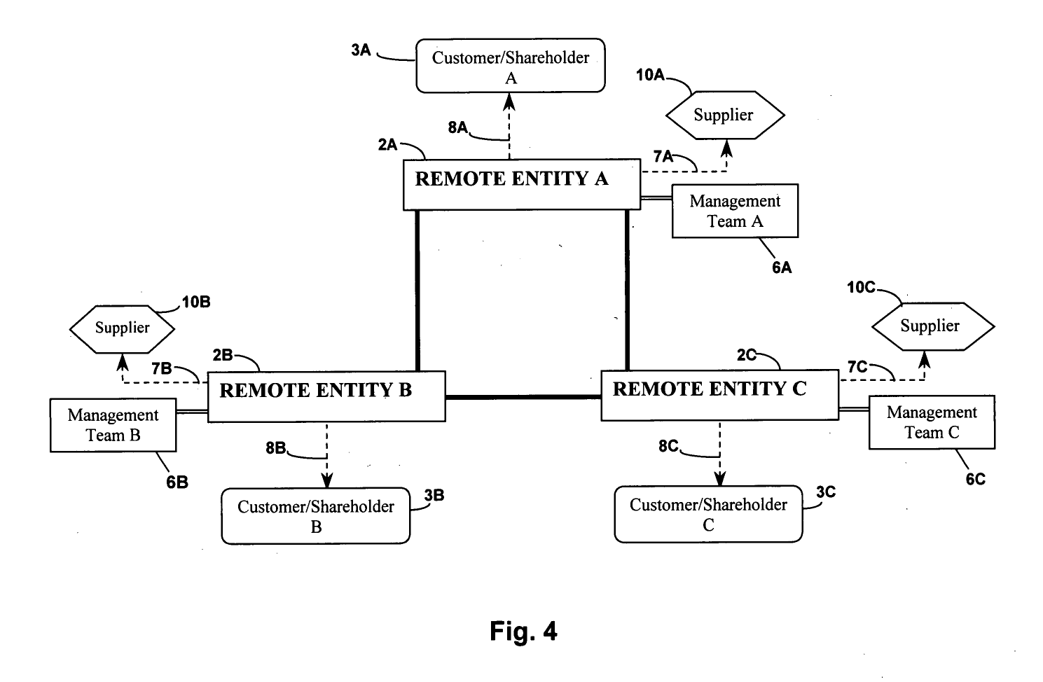

Still another embodiment of the present invention is a collaborative shared services business system (System) having multiple remote for-profit business Entities as shown in FIG. 4. To maintain efficiency and productivity as the number of shareholders 3A-3C increases over a wide geographic area, it may become effective to form one or more other remote Entities 2A-2C and group the customers/shareholders by location, e.g. Entity-Northern California, Entity-Southern California, and Entity-Texas. The embodiment follows the same general collaborative shared services business system strategy as mentioned above, except that each remote Entity 2A-2C can have its own separate management 6A-6C. Each remote Entity 2A-2C can be fully functional and independent, similar to a subsidiary. The means to distribute the costs that are saved and/or profits to the shareholders 3A-3C for operating efficiencies are in the form of but are not limited to patronage dividends, volume discounts, rebates, and warrants Such distribution 8A-8C is derived from income over costs and expenses or costs saved by each separate remote Entity 2A-2C and is distributed to its own customers/shareholders 3A-3C.

A feature of an embodiment of the present invention allows shared services to be managed by a for-profit business entity (Entity) that returns patronage dividends to its customers/shareholders with tax benefits pursuant to Subchapter T as shown in EXAMPLE 1. Costs saved by the Entity through collaborative management of business operational support services are included in the Entity's profits, and distributed as patronage dividends to the shareholders. Tax deferrals are afforded to the shareholders based on the allocation of the patronage dividends to the shareholders in proportion to the quantity or value of patronage business. In addition, the patronage dividends are paid pursuant to a pre-existing legal obligations, usually provided for in the bylaws of the Entity. Further, patronage dividends are determined with reference to net earnings of the Entity, and they are distributed timely. The Entity's membership is structured so that more than 20% of its equity or 20% of its voting power is owned by unrelated members or shareholders, or related members who are not included in a consolidated tax return, e.g. partnerships, LLCs, or foreign controlled corporations. Two key considerations in planning an Entity's membership structure to keep it outside a consolidated return of its members or shareholders are the requirements that: 1) ownership of the Entity's equity is held by its customers/shareholders in proportion to their patronage, and 2) each customer/shareholder has only one vote in governing the Entity. The costs saved by the Entity are included in profits, and return to the customers/shareholders as patronage dividends. The greater the profits, the greater the amount of taxes deferred. Consequently, increased collaborative shared services increase efficiency and maximize profitability in turn. Greater profits lead to greater tax benefits.

### EXAMPLE 1

| | AMOUNT | DEFERRAL |
|---|---|---|
| Budgeted purchases of services | 500,000,000 | |
| Assumed intercompany profit @ 2% | | 10,000,000 |
| Budgeted collaborative services costs | 150,000,000 | |
| Assumed fees with intercompany | 165,000,000 | 15,000,000 |
| profit @ 10% | | |
| Prepay 3.5 months of collaborative services | | |
| fees to Entity | | |
| Prepayment = 3.5/12 × 165,000,000 | | 50,000,000 |
| Assumed account receivables available for | 200,000,000 | |
| factoring 200,000,000 × assumed 10% | | 20,000,000 |
| factoring discount | | |
| TOTAL DEFERRED INCOME | | 95,000,000 |
| TAX RATE | | 40% |
| TAXES DEFERRED | | 38,000,000 |

Some other examples of tax deferrals available to shareholders if Subchapter T applies include, but are not limited to: permanent deferral of intercompany profit on purchases of services by the shareholders from the Entity; permanent deferral of intercompany profit on collaborative shared services provided by the Entity to its shareholders; permanent deferral for prepayment by the shareholders to the Entity of approximately 3½ months of collaborative service fees; permanent deferral of intercompany factoring discount on accounts receivable sold by shareholders to the Entity.

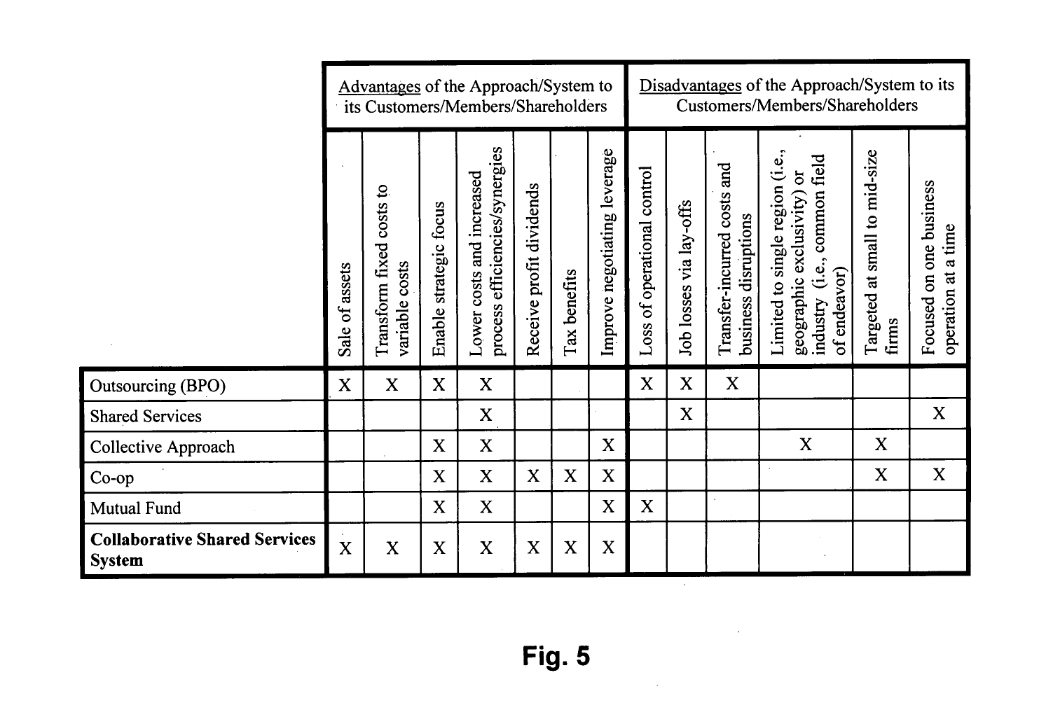

Under the embodiments of the present invention, the gains in productivity and savings will compound. A collaborative shared services business system (System) can offer its customers tangible financial benefits and significant process improvements. The chart illustrated in FIG. 5 compares the advantages and disadvantages of the collaborative shared services business system with the prior art. Some of the financial benefits of the System include: tax savings, balance sheet improvements on asset purchases, distribution of dividends, increased velocity of cash flow, and conversion of fixed overhead costs to variable expenses. The professional management of business operational support services or functions under the System results in better centralized business process practices which in turn lead to reductions in operating costs, fewer discrepancies in financial services, greater efficiency, highest performance, and greater job retention through reallocation and effective management of the collaborative shared services. Other key advantages of the System include the retention of control over business operations by the customers/shareholders. The System may also alternatively include use of the customers/shareholders as suppliers of the collaborative shared services, use of some of the Entity's profits to invest in technology and skill enhancements, improved cost structures, better leverage of economies of scale, and improved cross-functional issue resolution by having a focused team for rectifying customer and/or vendor issues.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

1. An entity for supporting a collaborative shared services business system, the entity comprising:
a for-profit corporation having one or more managers to manage the entity,
a means for performing one or more collaborative services as needed for the customers/shareholders; and
a means for distributing at least part of its earnings to each of its customers/shareholders;
wherein the entity is organized to allow the sale of shares of the entity to one or more customers/shareholders; accept the transfer of assets from the customers/shareholders; receive special tax treatment; and wherein the entity charges a fee for the collaborative shared services it provides to each customer/shareholder on a per transaction basis or based on the services provided during a specified period of time.

2. The entity according to claim 1, further comprising a means for outsourcing all or a portion of the entity's collaborative shared services to an unrelated supplier.

3. The entity according to claim 1, wherein the means for distributing earnings is through dividends to the shareholders and the special tax treatment allows for the entity to take a tax deduction for the dividends allocated to the shareholders.

4. The entity according to claim 1, wherein the entity does not receive special tax treatment but customers/shareholders receive tax deductible benefits.

5. The entity according to claim 1, further comprising at least one sub-entity under the direction of the entity, said sub-entity specializing in a particular collaborative shared service.

6. The entity according to claim 1, further comprising one or more remote entities, said remote entities being geographically separate from each other.

7. The entity according to claim 6, wherein each of the remote entities has a regional manager for managing each of the remote entities.

8. The entity according to claim 6, wherein ownership of the customers/shareholders belonging to one remote entity is not necessarily the same as the ownership of the customers/shareholders belonging to another remote entity.

9. A collaborative shared services business system comprising:
a. an entity;
b. at least one customer/shareholder;
c. an assets transfer from a given customer/shareholder to the entity;
d. a management scheme for the entity to manage the assets and provide one or more needed collaborative shared services to the customer/shareholder;
wherein the entity is a for-profit corporation and charges a fee for the collaborative shared services it provides to each customer/shareholder on a per transaction basis or based on the services provided during a specified period of time.

10. The collaborative shared services business system according to claim 9, further comprising an outsourcing mechanism to outsource all or a portion of the entity's collaborative shared services to an unrelated supplier.

11. The collaborative shared services business system according to claim 9, further comprising one or more remote entities, said remote entities being geographically separate from each other.

12. The collaborative shared services business system according to claim 9, further comprising at least one sub-entity under the direction of the entity, said sub-entity specializing in a particular collaborative shared service.

13. The collaborative shared services business system according to claim 9, wherein the entity distributes at least some of its profits to each customer/shareholder through dividends or in a form of deductible benefits.

14. The collaborative shared services business system according to claim 13, wherein the entity is entitled to special tax treatment that allows for the entity to take a tax deduction for the dividends allocated to the shareholders.

15. The collaborative shared services business system according to claim 13, wherein the deductible benefits comprise volume discounts, rebates and warrants.

16. A method for operating a collaborative shared services business system comprising:
a. establishing an entity, said entity being a for-profit corporation, and having one or more managers to manage the entity;
b. purchasing a portion of the entity through a purchase of shares of stock by one or more customers/shareholders;
c. transferring assets from each customer/shareholder to the entity;
d. providing needed collaborative shared services to each customer/shareholder;
e. distributing at least a portion of its profits to its shareholders, which include the customers/shareholders;
f. charging a fee for the collaborative shared services the entity provides to each customer/shareholder on a per transaction basis or based on the services provided during a specified period of time;
wherein the entity receive special tax treatment.

17. The method according to claim 16, further comprising outsourcing all or a portion of the entity's collaborative shared services to an unrelated supplier.

18. The method according to claim 16, wherein the at least a portion of the profits are allocated by way of dividends to the shareholders and the special tax treatment allows for the entity to take a tax deduction for the dividends allocated to the shareholders.

19. The method according to claim 16, wherein the entity does not receive special tax treatment and the distributing at least a portion of its profits to its shareholders is provided through volume discounts, rebates and warrants to the customers/shareholders.

20. The method according to claim 16, further comprising delegating all or a portion of the collaborative shared services to at least one sub-entity under the direction of the entity, said sub-entity specializing in a particular service.

21. The method according to claim 16, further comprising delegating all or a portion of the collaborative shared services to one or more remote entities, said remote entities being geographically separate from the entity.

22. The method according to claim 21, further comprising providing a separate regional manager to each remote entity for the management of each remote entity.

23. The method according to claim 21, further comprising distributing the purchase of shares of stock by the customers/shareholders to one or more specific remote entities, such that ownership of a given remote entity is not necessarily the same as the ownership of the customers/shareholders of another remote entity.
